(19) United States
(12) Patent Application Publication
(10) Pub. No.: US 2005/0239436 A1
(43) Pub. Date: Oct. 27, 2005

(54) Systems and methods for providing signals to a device to cause a task to be performed in an emergency situation

(76) Inventors: James C. Bell, Tifton, GA (US); Jolene C. Bell, Tifton, GA (US)

Correspondence Address: Jeramie J. Keys, Withers & Keys, P.O. Box 71355, Marietta, GA, 30007-1355, US

(21) Appl. No.: 10/833,241

(22) Filed: Apr. 27, 2004

(51) Int. Cl. G08G 1/00

(52) U.S. Cl. 455/404.2; 455/404.1

(57) ABSTRACT

Systems and methods provide for signals to be received at a device that cause a particular task to be performed at the device in an emergency situation. For example, a signal may be provided to a vehicle, cellular phone, or other device to cause an audio system of the device to provide an audible emergency broadcast system message to the operator and other occupants, such as a warning of inclement weather, accidents, and other impending dangers. As another example, a signal may be provided to a device to cause an audio system of the device to provide an audible alert about an approaching emergency vehicle. As another example, a signal may be provided to a vehicle to control a function of the vehicle, such as causing the engine to throttle down to slow the vehicle when being pursued by law enforcement.

### TECHNICAL FIELD

The present invention is related to performing tasks at a device normally under control of an operator in response to receiving remote signals. In particular, the present invention is related to tasks performed at the device in response to remote signals provided during emergency situations.

### BACKGROUND

Accidents caused by motor vehicles colliding with emergency vehicles responding to a call are a major problem. It is estimated that over 10,000 accidents are caused each year by occupants of vehicles being unaware of approaching emergency vehicles such as law enforcement, firefighters, and ambulances. It is further estimated that 20,000 people are injured or killed as a result of collisions with emergency vehicles. Another 75,000 accidents occur as a result of approaching or passing emergency vehicles. It is common for occupants of a vehicle to be unaware of approaching emergency vehicles even with the sirens activated, and the operator of the passenger vehicle involved in these accidents is at fault 70% of the time. This is often due to modern passenger vehicles increasing occupant comfort by including sound proofing and audio systems capable of substantial volume.

A large number of these accidents may also be caused by the pursuit by law enforcement officials of motor vehicles, which often results in both vehicles reaching high rates of speed. Passenger vehicles are often unable to avoid a collision due to the speed of the vehicles involved in the pursuit. One consequence is that motor vehicle accidents are thought to be the leading cause of death of law enforcement officers.

Accidents may also be caused by motor vehicles or pedestrians encountering dangerous areas. Occupants of a vehicle and pedestrians are often unaware of emergency situations such as inclement weather, accidents, and other dangerous situations that lie ahead. For example, motorists may be unaware of flooded areas of the roadway, collapsed bridges, or approaching severe weather events. Motorists and pedestrians may be unaware of natural gas leaks and other similar danger zones. While emergency broadcast system messages may exist to warn of emergencies, motorists and pedestrians may be unaware of or unable to receive such broadcasts.

### SUMMARY

Embodiments of the present invention address these issues and others by providing systems and methods that utilize remote signals to cause tasks to be performed by devices in emergency situations. Emergency broadcast system messages may be sent as a signal that is received and recognized as such a message and a corresponding audible message is then played through an audio system of the device, such as a vehicle or cellular telephone. Signals may be sent from approaching emergency vehicles that are received so that an audible alert about the approaching emergency vehicle is then played through the audio system of the device. Furthermore, a signal may be sent so that when received, a function of a vehicle is controlled, such as to shut down the engine and bring the vehicle to a stop when being pursued by law enforcement.

One embodiment is a system for causing an action at a remote device during an emergency situation. The system includes a transmitter under the control of emergency personnel, and the transmitter wirelessly transmits a command signal upon activation by the emergency personnel. A device is located remotely from the transmitter, and the device includes a control element that is under the control of an operator during normal operation. The device further includes an antenna that receives the command signals and a controller that acts upon the command signals received by the antenna to take control of the control element. As one example, the device may be a cellular phone and the control element is the audio system of the cellular phone such that the control signal causes the audio system to provide an audible alert to the operator of the cellular phone such as to warn of impending danger. As another example, the device may be a vehicle and the control element is the audio system of the vehicle such that the control signal causes the audio system to provide an audible alert to the occupants of the vehicle such as to warn of an approaching emergency vehicle. As another example, the device may be a vehicle and the control element is the engine throttle sensor of the vehicle such that the control signal interrupts and output of the engine throttle sensor to slow the car and to prevent the car from attempting to escape law enforcement.

Another embodiment is a method of providing information during emergency situations where a plurality of vehicles include a radio system that includes an antenna, radio, and speakers for providing normal commercial band radio operation and where the one or more vehicles also include a controller interconnected to the radio system. The method involves receiving a command signal in addition to commercial band broadcast radio through an antenna of each of the plurality of vehicles. It is detected at the controller of each of the plurality of vehicles that the command signal has been received. After detecting that the command signal has been received, the normal commercial band radio operation is interrupted at each of the plurality of vehicles to provide an audible message from the controller through the speakers. As an example, the command signal may cause an audible message to be provided that warns of impending danger or an approaching emergency vehicle.

Another embodiment is a method of controlling a function of a vehicle during an emergency situation where the vehicle includes a radio system having an antenna that receives normal commercial band radio broadcasts, a control system, and a controller interconnected to the radio system that detects command signals. The method involves receiving a command signal through the antenna and detecting at the controller that the command signal has been received. After receiving the command signal, a control signal is issued from the controller to the control system to control a function of the vehicle. As an example, the command signal may cause a control signal to interrupt an output of an engine throttle sensor to thereby slow the vehicle if it is being pursued by law enforcement.

### DESCRIPTION OF THE DRAWINGS

FIG. 1A is a diagram of an emergency vehicle system that transmits command signals to a remote device such as another vehicle to cause a function to occur at the remote device.

FIG. 1B is a diagram of an emergency vehicle equipped to transmit a command signal that identifies a specific vehicle to act upon the command signal.

FIG. 2A shows the logical operations performed by the emergency vehicle system to provide an audible alert to remote devices.

FIG. 2B shows the logical operations performed by the emergency vehicle system to provide an emergency stop command to a specific remote vehicle.

FIG. 3 is a diagram of an emergency broadcasting system that transmits command signals to a remote device such as vehicles or cellular telephones to provide emergency broadcasts.

FIG. 4 shows the logical operations performed by the emergency broadcasting system.

FIG. 5 is a diagram of a vehicle system that has been retrofit into existing systems of a vehicle and that receives remotely generated command signals to perform a requested function.

FIG. 6 is a diagram of a vehicle system that is included in a replacement radio system installed in a vehicle and that receives remotely generated command signals to perform a requested function.

FIG. 7 is a diagram of a vehicle system that is included in the computer system of a vehicle and that receives remotely generated command signals to perform a requested function.

FIG. 8 shows the logical operations performed by the vehicle system to provide an audible alert about an approaching emergency vehicle to occupants of the vehicle in response to receiving remotely generated command signals.

FIG. 9 shows the logical operations performed by the vehicle system to provide emergency broadcast messages to occupants of the vehicle in response to receiving remotely generated command signals.

FIG. 10 shows the logical operations performed by the vehicle system to slow the vehicle to a stop in response to receiving remotely generated command signals.

FIG. 11 is a diagram of a cellular telephone system that is included in cellular telephone circuitry and that receives remotely generated command signals to perform a function.

FIG. 12 shows the logical operations performed by the cellular telephone system to provide emergency broadcast messages to the cellular telephone user in response to receiving remotely generated command signals.

### DETAILED DESCRIPTION

Embodiments of the present invention provide for command signals to be transmitted to remote devices to cause a particular function to occur at the remote device during an emergency situation. The function is performed by a control element that is typically under control of the operator of the remote device, such as the audio output of a cellular telephone or radio system of a vehicle. Accordingly, the remote device responds to the command signals to perform the function that is relevant to the particular emergency situation. For example, an emergency system broadcast may be provided through the audio output of a cellular phone or radio system of a vehicle even if the cellular phone or radio system is otherwise in use by the operator. As other examples, a warning of an emergency vehicle that is approaching may be announced through the audio output of the radio system of a vehicle or the throttle control of a vehicle may be interrupted to bring the vehicle to a stop when being pursued.

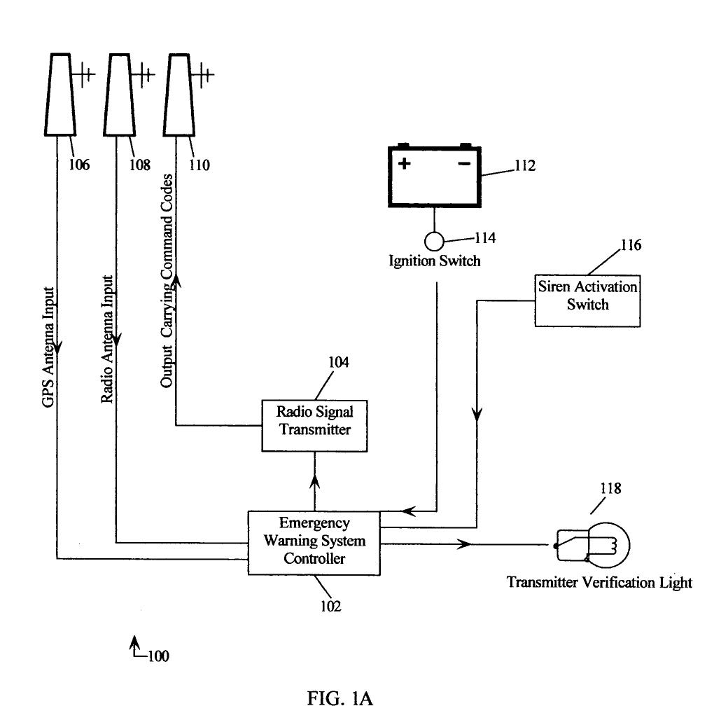

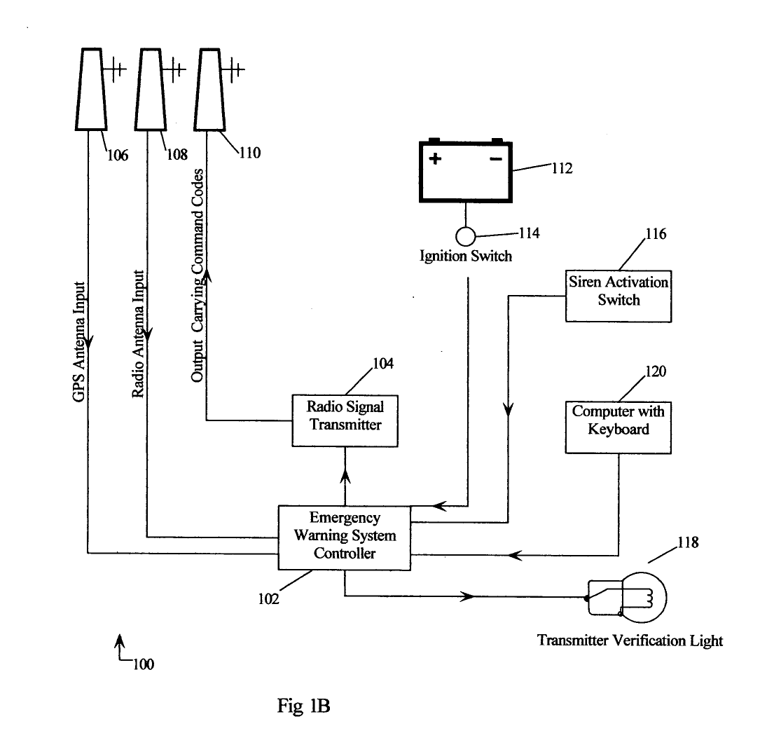

FIG. 1A illustrates the components included in an emergency vehicle to allow the emergency vehicle to transmit command signals to other vehicles so that the radio systems of the other vehicles will provide an audible warning to occupants. This ensures that occupants of the other vehicles are made aware of the approaching emergency vehicle so that they may exercise caution to avoid a collision and to avoid obstructing the passage of the emergency vehicle.

The emergency vehicle system 100 of FIG. 1A, as well as the other systems described below, includes an emergency warning system controller 102. As described herein with respect to various systems and devices, a controller such as controller 102 of FIG. 1A may be one of many well-known multi-purpose logic devices or combinations of devices having built-in bi-directional communications abilities and having configurable input-output connectivity for sending and receiving data over various protocols. The device may employ firmware to provide the logical operations discussed herein and/or may employ hard-wired digital logic. Accordingly, the term controller is used herein in a generic sense to refer to many types of devices that are capable of performing the functions discussed. However, it will be appreciated that application specific integrated circuitry (“ASIC”) can provide such functionality while providing a significant economic advantage.

The controller 102 of FIG. 1A receives various input signals and generates various output signals to provide the transmission of command signals and to indicate to the operator of the emergency vehicle that the warning system is working properly. The controller 102 may receive electrical power from the electrical system 112 already present in an emergency vehicle. The electrical system 112 typically includes a direct current battery that is charged by a charging system driven by the engine of the emergency vehicle. The electrical power provided to the controller 102 may be controlled by the ignition switch 114 of the vehicle so that the controller 102 is operable to transmit command signals only when the vehicle has been switched on.

In addition to receiving electrical power as input, the controller 102 also receives an input signal from a switch to activate the controller 102 during emergency situations. A siren activation switch 116 that the operator of the emergency vehicle uses to activate the siren may also act as the switch to initiate the transmission of command signals by the controller 102. Upon activation by the switch 116, the controller 102 then provides a command signal to a radio transmitter 104. Although shown as a separate component, the radio transmitter 104 may also be integrated into the controller 102. The transmitter 102 places the command signal on a carrier wave of a given frequency or range of frequencies and then transmits them wirelessly from an antenna 110.

The frequency or range of frequencies that the command signals are transmitted upon may be selected based upon spectrum controlled by a government agency, such as the Federal Communications Commission (“FCC”) of the United States. The FCC may specify a particular frequency band that should be used for transmission of command signals for emergency situations so that these signals do not conflict with other radio frequency transmissions, such as commercial band radio, citizen band radio, and cellular telephones. The frequency band allotted allows for one or more channels to be established, with each channel having a center frequency. The command signals may then be transmitted on one or more of the channels defined within the allotted frequency range. As discussed below, the receiver of controllers of the emergency vehicle as well as remote devices may then be permanently tuned to receive signals on one or more of the channels within the allotted frequency band. Therefore, the operator of the remote device does not need to tune to the proper channel in order for the remote device to receive the command signals.

To ensure that the command signal transmissions are being properly transmitted for reception by remote devices, the emergency vehicle system 100 may also include a radio antenna 108 that receives the signal that has been transmitted from the antenna 110. The antenna 108 feeds the signal back to the controller 102 which includes an integrated radio receiver. The controller 102 then detects that the command signal is being received and provides an output to turn on a transmitter verification light 118 which can be seen by the operator of the emergency vehicle.

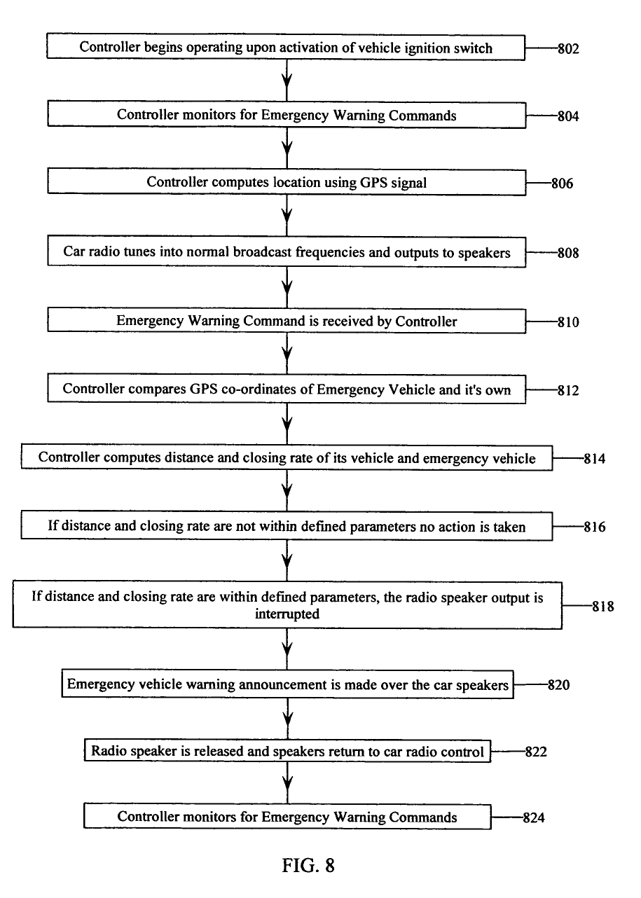

In addition to receiving radio input, the emergency vehicle system 100 may also include a global positioning system (“GPS”) antenna 106 that feeds a GPS signal to a GPS receiver integrated into the controller 102. The controller 102 may then determine the coordinate position of the emergency vehicle and may include this coordinate position within the command signal that is being transmitted. This allows the remote devices receiving the command signal to determine whether the location of the remote device is close enough to the emergency vehicle so that the command signal should be acted upon. This is discussed in more detail below with reference to FIG. 8.

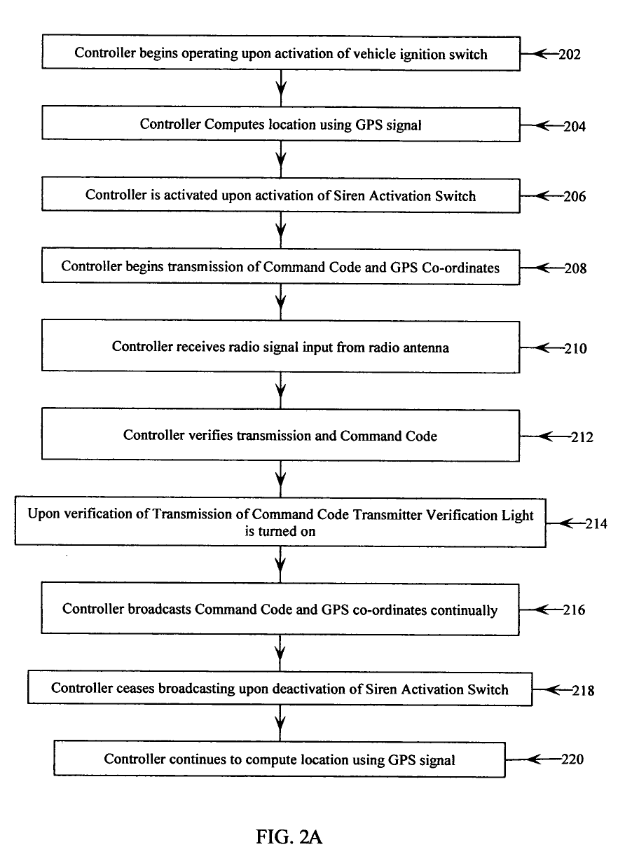

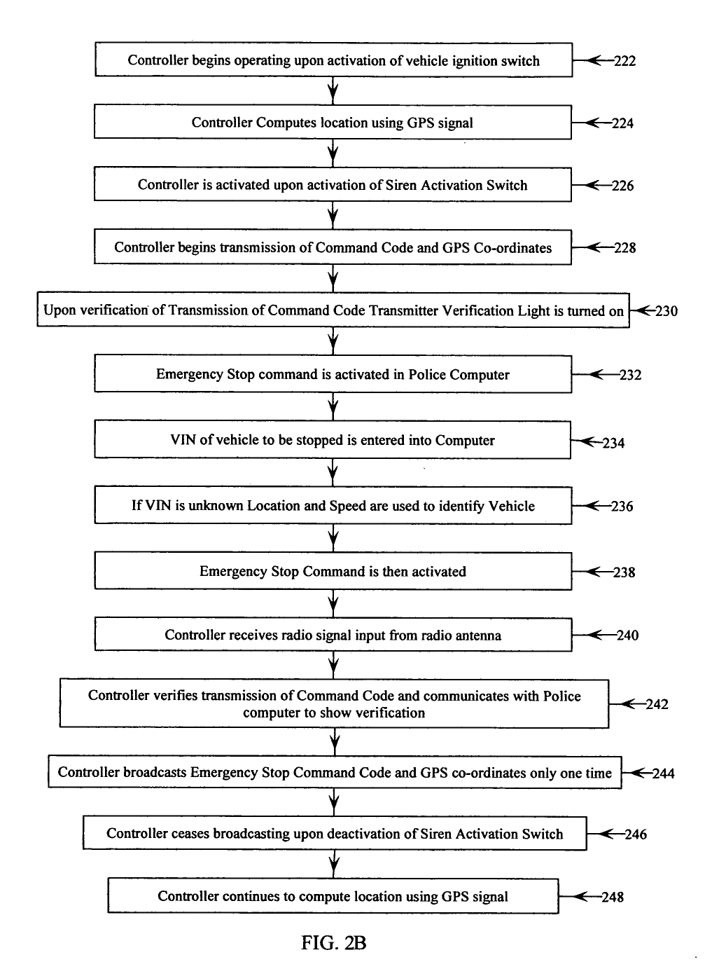

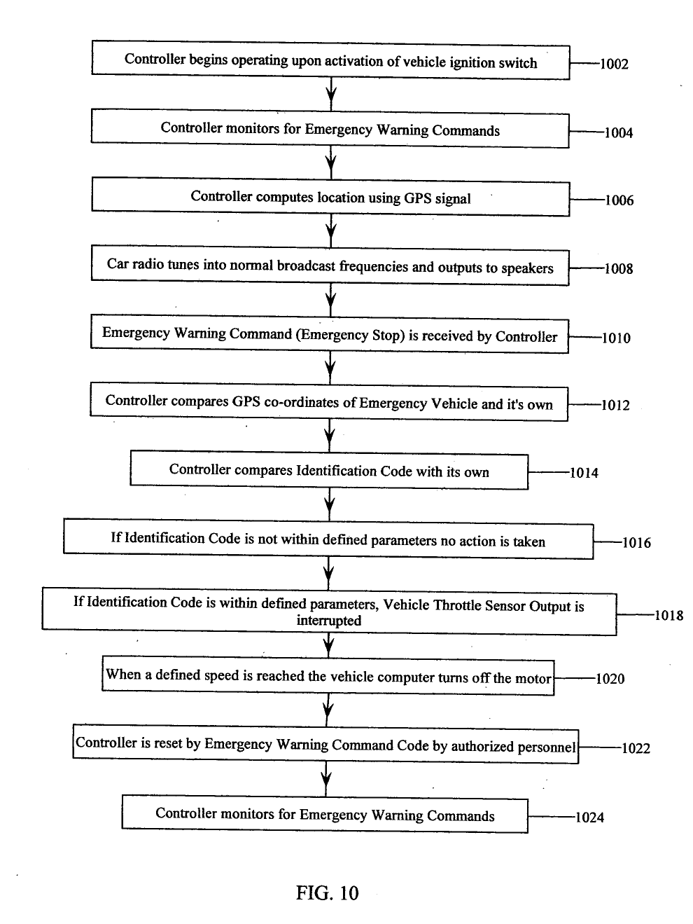

In some embodiments as shown in FIG. 1B, the emergency vehicle system 100′ may also include a computer 120 with a keyboard that allows the operator to enter specific information to be included in the command signal being transmitted. For example, law enforcement may need to send a command signal from a police vehicle that includes system 100′ to a vehicle being pursued to cause the vehicle being pursued to slow to a stop rather than obey the throttle commands of the driver. Because it is a specific vehicle to be stopped, the command signal must identify the specific vehicle so that all vehicles within range of the command signal do not act upon the stop command code. Accordingly, the police officer may enter a vehicle identifier into the computer 120 via the keyboard. Forms of vehicle identification entered into the computer 120 may include the vehicle identification number when available by performing a look-up of the license plate number in the vehicle registration database. The vehicle identification may include other identifiers such as proximity and speed value. These forms of vehicle identification and how they are used to identify the vehicle to act upon the command code are discussed in more detail below with reference to FIGS. 2B and 10.

FIG. 2A shows the logical operations that occur within the emergency vehicle system 100 to provide a command signal to remote devices such as other vehicles to cause an audible alert to be provided to warn others that the emergency vehicle is approaching. Initially, the controller 102 begins operation via activation of the ignition switch 114 at switch operation 202. Then, the controller 102 computes the coordinate location of the emergency vehicle using the GPS signal at location operation 204. The controller 102 is then activated to transmit a command signal upon activation of the siren via switch 116 at switch operation 206. At this point, the command signal is being transmitted from antenna 110 with a command code and location data at transmission operation 208. The command code specifies that an audible message should be provided to alert motorists to an approaching emergency vehicle. The command signal may be encrypted through one of various, well-known encryption schemes to minimize the chance that the command code can be discovered by eavesdropping and then re-used by someone with malicious intent.

The controller 102 receives the radio signal that has been transmitted through the antenna 108 at reception operation 210. The controller verifies that the transmission has been received and that the transmission contained the command code that causes the audible alert about an approaching emergency vehicle at verification operation 212. Once the transmission and command code have been verified, the controller 102 turns on the verification light 118 at light operation 214 to signal to the operator of the emergency vehicle that the command signal is being properly transmitted to other vehicles to make the occupants aware of the emergency vehicle.

The controller 102 continues to broadcast the command signal with the appropriate command code and the updated location data at broadcast operation 216. Thus, while the emergency vehicle is proceeding to its destination, other vehicles within range of the command signal transmission are continuously receiving the location data and the command to provide the audible alert if within a defined distance from the emergency vehicle (and if a closing rate between the vehicles is satisfied for certain embodiments). Once the emergency vehicle has reached its destination or the emergency situation has otherwise ended, the operator of the emergency vehicle switches off the siren which then deactivates the transmission of the command signal by the controller 102 at deactivation operation 218. The controller 102 continues computing the location of the emergency vehicle from the GPS signal at location operation 220 so that the location data is immediately available upon the next activation of the command signal transmission.

FIG. 2B shows the logical operations that occur within the emergency vehicle system 100 to provide a command signal to other vehicles to disrupt an output of a throttle sensor of the remote vehicles so that they slow to a stop when being pursued. Initially, the controller 102 begins operation via activation of the ignition switch 114 at switch operation 222. Then, the controller 102 computes the coordinate location of the emergency vehicle using the GPS signal at location operation 224. The controller 102 is then activated to transmit a command signal upon activation of the siren via switch 116 at switch operation 226. At this point, the command signal is being transmitted from antenna 110 with a command code and location data at transmission operation 228. The command code of this initial command signal transmission specifies that an audible message should be provided to alert motorists to an approaching emergency vehicle. The command signal may be encrypted through one of various, well-known encryption schemes to minimize the chance that the command code can be discovered by eavesdropping and then re-used by someone with malicious intent.

The controller 102 receives the radio signal that has been transmitted through the antenna 108 and verifies that the transmission has been received and that the transmission contained the command code that causes the audible alert about an approaching emergency vehicle at verification operation 230. Once the transmission and command code have been verified, the controller 102 turns on the verification light 118.

At this point, the emergency vehicle has begun to pursue another vehicle and the operator of the emergency vehicle, such as a police officer, wishes for the vehicle being pursued to slow to a stop. Once it is evident to the police officer that the operator of the other vehicle is attempting to flee rather than stop, the police officer then activates an emergency stop command via a selection on the computer 120 at stop operation 232. The emergency stop command program of the computer 120 requests a vehicle identifier at identification operation 234. The vehicle identifier ensures that the command signal to be transmitted will identify that vehicle to be stopped so that other vehicles will ignore the stop command code of the command signal.

The vehicle identifier entered by the police officer may be one of various types of information. The most effective vehicle identifier that provides the most assurance of stopping the correct vehicle is the vehicle identification number (“VIN”). The police officer may obtain the VIN by looking up the license plate in the registration database via the computer 120 or by requesting the information over a radio call to a police station. If the VIN is not available, such as because the vehicle being pursued has no license tag or because the license tag of the vehicle is not registered to the vehicle, then the police officer may enter alternative identification information at identification operation 236. For example, the officer may enter an approximate speed the vehicle is traveling and an approximate distance the vehicle is from the police vehicle to define a coverage area. Typically, the police vehicle will be in close proximity to the vehicle being pursued, and the vehicle being pursued will have a speed significantly higher than that of surrounding vehicles such that this information singles out the vehicle being pursued.

After entering identification information, the computer 120 then activates the controller 102 to send the command signal via antenna 110 at activation operation 238. This command signal specifies the command code for the emergency stop function, specifies the identification of the vehicle to be stopped, and specifies the GPS location coordinates of the police vehicle. The controller 102 also receives the command signal from the antenna 108 at reception operation 240. The controller 102 then verifies the contents of the command signal including the command code and communicates with the computer 120 to provide a display of the verification for the police officer at verification operation 242. As noted at transmission operation 244, the command signal containing the emergency stop command code and the GPS coordinates of the police vehicle are transmitted only one time to lessen the likelihood that another vehicle might inadvertently respond to the stop command.

Once the police or other emergency vehicle has successfully stopped the vehicle being pursued or the emergency situation has otherwise ended, the police officer switches off the siren which then deactivates the transmission of the command signal by the controller 102 at deactivation operation 246. The controller 102 continues computing the location of the emergency vehicle from the GPS signal at location operation 248 so that the location data is immediately available upon the next activation of a command signal transmission.

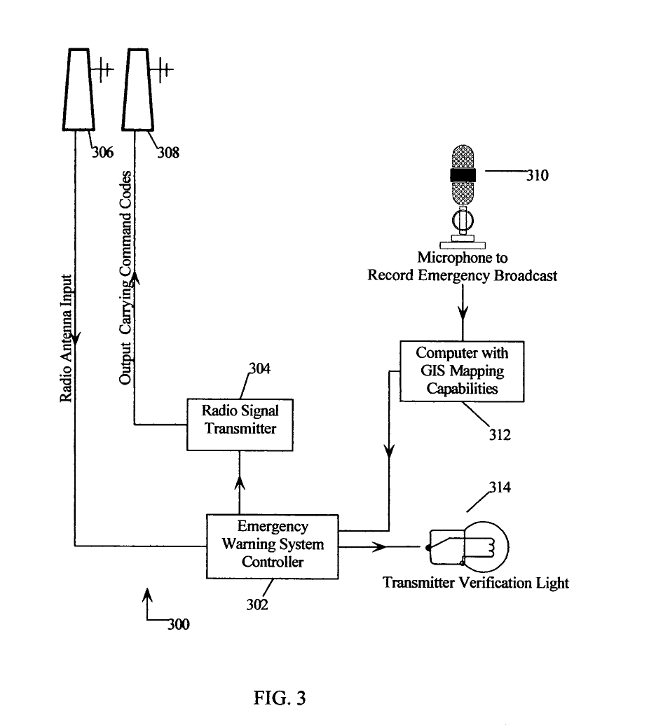

FIG. 3 illustrates the components included in an emergency broadcasting system to allow the emergency broadcasts to be transmitted via command signals to remote devices such as vehicles and cellular telephones so that the broadcast is provided to individuals. This ensures that individuals with remote devices, such as occupants of vehicles and users of cellular telephones, are made aware of impending dangers and other emergency situations.

The emergency broadcasting system 300 of FIG. 3 includes an emergency warning system controller 302. The controller 302 receives various input signals and generates various output signals to provide the transmission of command signals including the broadcast message and to indicate to the operator of the emergency broadcasting system that the warning system is working properly. For embodiments where the emergency broadcasting system is located within a building, the controller 302 and other components may receive power from a public utility. For embodiments where the emergency broadcasting system is located within a vehicle, the controller 302 may receive electrical power from the electrical system already present in the vehicle as described for FIG. 1A.

In addition to receiving electrical power as input, the controller 302 also receives an input signal from a computer 312 or other device such as a simple switch to activate the controller 302 during emergency situations when an emergency broadcast is necessary. For embodiments where the computer 312 is used to activate the command signal transmission, the computer 312 may also provide geographic information system (“GIS”) mapping capabilities so that an operator may determine location coordinates that define an area of relevance for the broadcast. These location coordinates may then be provided to the controller 302 for inclusion in the command signal transmission.

In addition to providing the location coordinates, the computer 312 or other switching device may interconnect a microphone 310 to the controller 302 so that an audible message may be spoken by an operator and then broadcast within command signals from the emergency broadcast system 300. Thus, audible messages may be generated and broadcast in real time, which enables the audible message to be updated and remain current as the impending danger evolves. For example, the path of a tornado may be continuously broadcast from the emergency broadcasting system 300 to provide immediate notification to individuals having remote devices responsive to the command signals.

Upon activation by the computer 312 or other switching device, the controller 302 then provides a command signal to a radio transmitter 304. Although shown as a separate component, the radio transmitter 304 may also be integrated into the controller 302. The transmitter 302 places the command signal on a carrier wave of a given frequency or range of frequencies and then transmits them wirelessly from an antenna 308.

To ensure that the command signal transmissions are being properly transmitted for reception by remote devices, the emergency broadcast system 300 may also include a radio antenna 306 that receives the signal that has been transmitted from the antenna 308. The antenna 306 feeds the signal back to the controller 302 which includes an integrated radio receiver. The controller 302 then detects that the command signal is being received and provides an output to turn on a transmitter verification light 314 which can be seen by the operator of the emergency broadcast system 300.

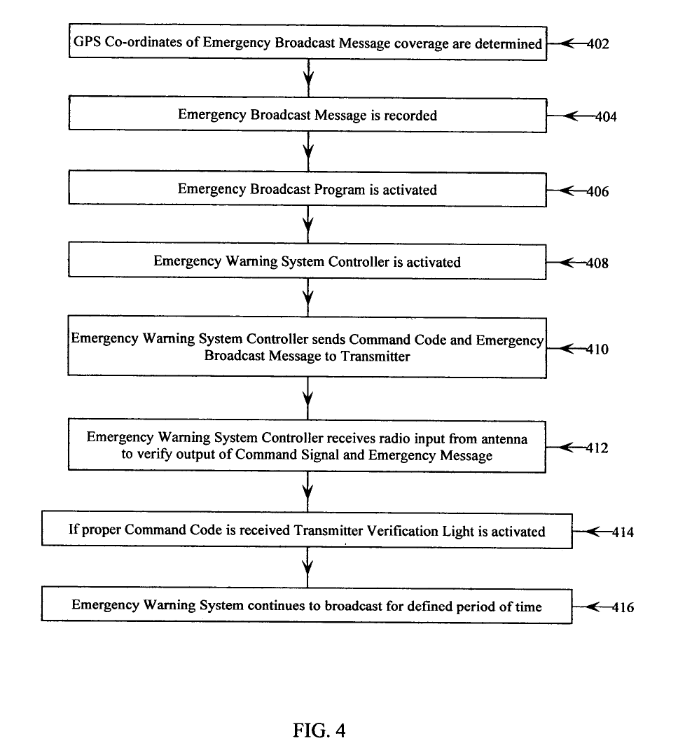

FIG. 4 shows the logical operations that occur within the emergency broadcast system 300 to provide a command signal to remote devices such as other vehicles or cellular telephones to cause an audible message to be provided to warn others of an emergency situation. Initially, the range of GPS coordinates for the coverage area that the message is intended for is found by the operator utilizing the GIS mapping system of the computer 312 at coverage operation 402. Next, the operator records the message by speaking into the microphone 310 while the computer 312 creates a sound file at recording operation 404. The operator then activates an emergency broadcast program of the computer 312 which generates a signal containing the range of location coordinates and the audio from the sound file at program operation 406.

The controller 302 is then activated by the signal from the computer 312 to transmit a command signal containing command codes, the location coordinate data, and the audio of the sound file at activation operation 408. At this point, the command signal is being transmitted from antenna 308 with a command code, location data, and emergency broadcast message from the sound file at transmission operation 410. The command code specifies that the emergency broadcast message should be provided to alert the individual to the emergency situation. As with the transmission from the emergency vehicle system 100, the command signal transmitted by the emergency broadcast system 300 may be encrypted through one of various, well-known encryption schemes to minimize the chance that the command code can be discovered by eavesdropping and then re-used by someone with malicious intent.

The controller 302 receives the radio signal that has been transmitted through the antenna 306 at reception operation 412. The controller 302 verifies that the transmission has been received and that the transmission contained the command code that causes the emergency broadcast message to be provided at verification operation 412. Once the transmission and command code have been verified, the controller 302 turns on the verification light 314 at light operation 414 to signal to the operator of the emergency broadcast system 300 that the command signal is being properly transmitted to remote device to make the individuals aware of the emergency situation.

The controller 302 continues to broadcast the command signal with the appropriate command code and the updated location data for a period of time defined by the operator at broadcast operation 416. Thus, while the coverage area for the emergency situation may be continuously changing, such as for the path of a tornado, remote devices within range of the command signal transmission are continuously receiving the location data specifying the intended coverage area and the command to provide the emergency broadcast message if within the coverage area.

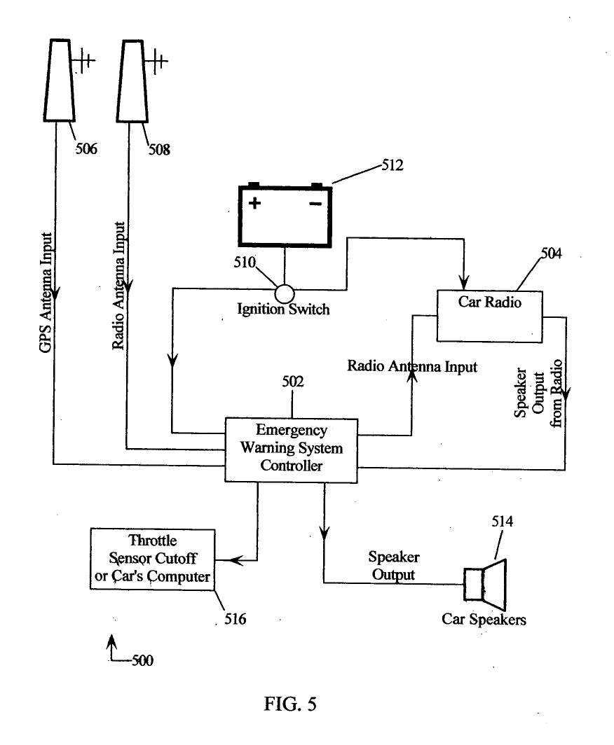

FIG. 5 illustrates the components that may be retrofitted to a passenger vehicle to allow the passenger vehicle to receive command signals and act upon the command signals to perform a particular function by taking control of a control element of the vehicle. In the example of FIG. 5, the control elements include speakers 514 and/or the engine throttle sensor 516 or engine computer. The controller 502 taking control of the control element ensures that the desired function is performed regardless of the state of operation of the vehicle. For example, the occupants may be listening to a normal commercial band radio broadcast when a command signal to provide an emergency broadcast or an emergency vehicle alert is received. The emergency broadcast or emergency vehicle alert takes priority and is provided through the audio system in place of the normal commercial band radio broadcast. Accordingly, occupants of the vehicle are made aware of the emergency situation such as an impending danger or an approaching emergency vehicle so that they may exercise caution.

The passenger vehicle system 500 of FIG. 5 includes an emergency warning system controller 502. The controller 502 receives various input signals and generates various output signals to provide for execution of a function specified by the command signals. The controller 502 may receive electrical power from the electrical system 512 already present in a passenger vehicle. As with the emergency vehicle system 100 of FIG. 1A, the electrical system 512 typically includes a direct current battery that is charged by a charging system driven by the engine of the passenger vehicle. The electrical power provided to the controller 502 may be controlled by the ignition switch 510 of the vehicle so that the controller 502 is operable to receive and execute command signals only when the vehicle has been switched on. Once switched on, the controller 502 remains in an active mode listening for command signals.

In addition to receiving electrical power as input, the controller 502 also receives command signals that have been received by a radio system antenna 508 that is already standard in vehicles and that is otherwise used to receive commercial band radio broadcasts. The command signal that has been received by the antenna 508 is channeled to the controller 502 where the various components of the command signals are extracted. As discussed above, the command signals include command codes that specify the function to be performed, location data that either specifies the location of an emergency vehicle or that specifies a range of locations of an emergency broadcast coverage area, and emergency broadcast messages for command signals sent from an emergency broadcast system. Furthermore, the command signals may provide an identification value of a remote device such as a vehicle where the command signal is intended to be acted upon by a specific remote device rather than all remote devices within a given area.

As mentioned above, the controller 502 includes a radio frequency receiver that is permanently tuned to one or more channels that are dedicated to the command signal transmissions. Thus, the operator of the vehicle is not required to tune the controller 502 to any particular channel prior to receiving a command signal. Accordingly, the controller 502 receives and acts upon the command signal without any action being taken by the operator. Furthermore, the action that occurs may be counter to the wishes of the operator of the vehicle such as where an emergency stop command has been transmitted to the vehicle during pursuit by law enforcement.

During the retrofitting process, the controller 502 is installed in-line between the existing antenna 508 and the antenna input of the existing car radio 504. The controller 502 acts as a pass-through between the antenna 508 and car radio 504 to allow commercial band radio broadcasts to be tuned in by the car radio 504 from the antenna 508. The controller 502 may also be installed in-line between the speaker output of the car radio 504 and the speakers 514. The controller 502 acts as a pass-through between the car radio 504 and speakers 514 so that normal radio broadcasts, audio cassettes, audio compact discs, and other audio sources of the car radio 504 continue to be played through the speakers 514. However, the controller 502 includes switching circuitry to intervene and disconnect the speakers 514 from the speaker output of the radio 504 and instead provide audio signals to the speakers 514 that correspond to the command signal. Such audio signals may be pre-programmed messages stored by the controller 502, such as generic alerts about approaching emergency vehicles, or may be contained within the command signal itself, such as the audio content of the emergency broadcast message.

In addition to providing an output signal to the speakers 514 as one function to be performed, the controller 502 may additionally or alternatively interrupt the output signal of the engine throttle sensor to cause the engine computer to detect that no throttle is being applied by the operator so that the car continuously slows until it stops. Furthermore, the controller 502 may provide a kill signal to the engine computer to kill the engine of the vehicle. This allows law enforcement to send a command signal to a vehicle and cause the vehicle to slow to a stop when being pursued so that a high-speed pursuit does not occur. As described below, the controller 502 may be configured to determine whether the vehicle is within the proper area identified by the command signal and/or whether the vehicle has been properly identified by the command signal prior to performing the command requested by the command signal.

In addition to receiving radio input, the passenger vehicle system 500 may also include a global positioning system (“GPS”) antenna 506 that feeds a GPS signal to a GPS receiver integrated into the controller 502. The controller 502 may then determine the coordinate position of the passenger vehicle and may compare this coordinate position to the location coordinates or range of coordinates provided in the command signal that is simultaneously being received. This allows the controller 502 to determine whether its location is within the parameters for acting upon the command signal. For example, the controller 502 may determine whether the vehicle is close enough to an emergency vehicle so that the command signal should be acted upon to provide an alert about the emergency vehicle through the speakers 514. As another example, the controller 502 may determine whether the vehicle is within a range of coordinates defining a coverage area of an emergency broadcasting message prior to providing the message through the speakers 514.

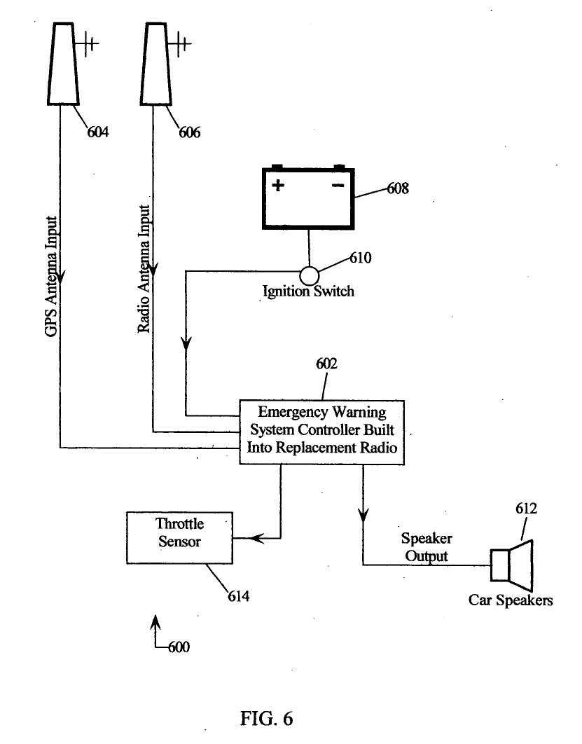

FIG. 6 illustrates the components that may be included in a replacement radio added to a passenger vehicle to allow the passenger vehicle to receive command signals and act upon the command signals to perform a particular function by taking control of a control element of the vehicle. As in the example of FIG. 5, the control elements include speakers 612 and/or the engine throttle sensor 614 or engine computer.

The passenger vehicle system 600 of FIG. 6 includes an emergency warning system controller 602 that is built-in to a replacement radio that also tunes in commercial band broadcast radio. The controller 602 receives various input signals and generates various output signals to provide for execution of a function specified by the command signals. The controller 602 may receive electrical power from the electrical system 608 already present in a passenger vehicle. As with the passenger vehicle system 500 of FIG. 5, the electrical system 608 typically includes a direct current battery that is charged by a charging system driven by the engine of the passenger vehicle. The electrical power provided to the controller 602 may be controlled by the ignition switch 610 of the vehicle so that the controller 602 is operable to receive and execute command signals only when the vehicle has been switched on. Once switched on, the controller 602 remains in an active mode listening for command signals.

In addition to receiving electrical power as input, the controller 602 also receives command signals that have been received by a radio system antenna 606 that is already standard in vehicles and that is otherwise used to receive commercial band radio broadcasts. The command signal that has been received by the antenna 606 is channeled to the controller 602 where the various components of the command signals are extracted.

As mentioned above, the controller 602 includes a radio frequency receiver that is permanently tuned to one or more channels that are dedicated to the command signal transmissions in addition to an agile radio frequency receiver that the operator can tune to one of various commercial frequencies. Thus, the operator of the vehicle is not required to tune the controller 602 to any particular channel prior to receiving a command signal. Accordingly, the controller 602 receives and acts upon the command signal without any action being taken by the operator.

The controller 602 built-in to the replacement radio is installed in the normal way any radio is installed in a vehicle. The controller 602 directly connects to the existing antenna 404. Because the commercial band radio is integrated with the controller 602, the controller 602 is not required to pass-through commercial band signals to a separate car radio. The controller 602 also directly connects to the existing speakers 612. Again, because the commercial band radio is integrated with the controller 602, the controller 602 is not required to pass-through signal from a separate car radio 604 to the speakers 612. However, the controller 602 includes switching circuitry to intervene and disconnect the speakers 612 from the speaker output of the integrated radio and instead provides audio signals to the speakers 612 that correspond to the command signal. As with the previous example, such audio signals may be pre-programmed messages stored by the controller 602, such as generic alerts about approaching emergency vehicles, or may be contained within the command signal itself, such as the audio content of the emergency broadcast message.

In addition to providing an output signal to the speakers 612 as one function to be performed, the controller 602 may additionally or alternatively interrupt the output signal of the engine throttle sensor to cause the engine computer to detect that no throttle is being applied by the operator so that the car continuously slows until it stops. Furthermore, the controller 602 may provide a kill signal to the engine computer to kill the engine of the vehicle. This allows law enforcement to send a command signal to a vehicle and cause the vehicle to slow to a stop when being pursued so that a high-speed pursuit does not occur. As described below, the controller 602 may be configured to determine whether the vehicle is within the proper area identified by the command signal and/or whether the vehicle has been properly identified by the command signal prior to performing the command requested by the command signal.

In addition to receiving radio input, the passenger vehicle system 600 may also include a global positioning system (“GPS”) antenna 604 that feeds a GPS signal to a GPS receiver integrated into the controller 602. The controller 602 may then determine the coordinate position of the passenger vehicle and may compare this coordinate position to the location coordinates or range of coordinates provided in the command signal that is simultaneously being received. This allows the controller 602 to determine whether its location is within the parameters for acting upon the command signal.

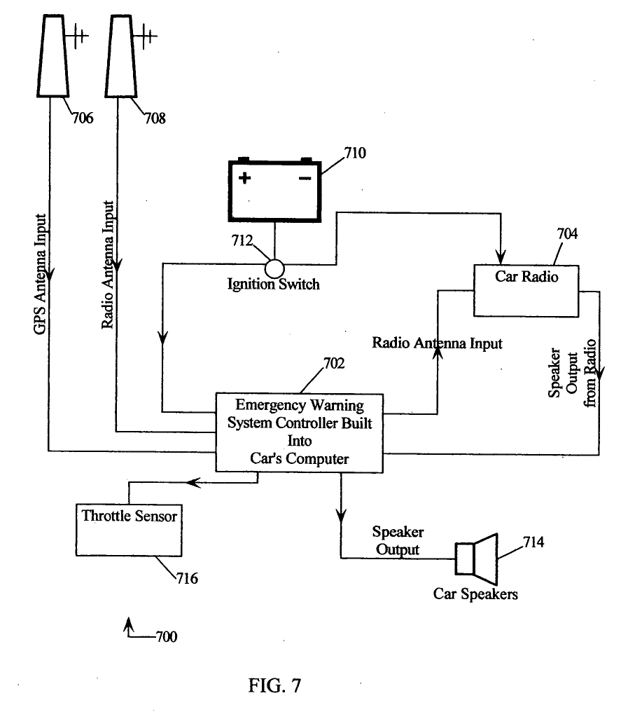

FIG. 7 illustrates the components that may be included in the original equipment of a passenger vehicle to allow the passenger vehicle to receive command signals and act upon the command signals to perform a particular function by taking control of a control element of the vehicle. In the example of FIG. 7, the control elements include speakers 714 and/or the engine throttle sensor 716 or engine computer.

The passenger vehicle system 700 of FIG. 7 includes an emergency warning system controller 702 that is built into the computer of the vehicle. The controller 702 receives various input signals and generates various output signals to provide for execution of a function specified by the command signals. The controller 702 may receive electrical power from the electrical system 710 already present in a passenger vehicle. As with the emergency vehicle system 600 of FIG. 6, the electrical system 710 typically includes a direct current battery that is charged by a charging system driven by the engine of the passenger vehicle. The electrical power provided to the controller 702 may be controlled by the ignition switch 712 of the vehicle so that the controller 702 is operable to receive and execute command signals only when the vehicle has been switched on. Once switched on, the controller 702 remains in an active mode listening for command signals.

In addition to receiving electrical power as input, the controller 702 also receives command signals that have been received by a radio system antenna 708 that is already standard in vehicles and that is otherwise used to receive commercial band radio broadcasts. The command signal that has been received by the antenna 708 is channeled to the controller 702 where the various components of the command signals are extracted.

As mentioned above, the controller 702 includes a radio frequency receiver that is permanently tuned to one or more channels that are dedicated to the command signal transmissions. Thus, the operator of the vehicle is not required to tune the controller 702 to any particular channel prior to receiving a command signal. Accordingly, the controller 702 receives and acts upon the command signal without any action being taken by the operator. Furthermore, the action that occurs may be counter to the wishes of the operator of the vehicle such as where an emergency stop command has been transmitted to the vehicle during pursuit by law enforcement.

The controller 702 is installed in-line between the antenna 708 and the antenna input of the existing car radio 704. The controller 702 acts as a pass-through between the antenna 708 and car radio 704 to allow commercial band radio broadcasts to be tuned in by the car radio 704 from the antenna 708. The controller 702 may also be installed in-line between the speaker output of the car radio 704 and the speakers 714. The controller 702 acts as a pass-through between the car radio 704 and speakers 714 so that normal radio broadcasts, audio cassettes, audio compact discs, and other audio sources of the car radio 704 continue to be played through the speakers 714. However, the controller 702 includes switching circuitry to intervene and disconnect the speakers 714 from the speaker output of the radio 704 and instead provide audio signals to the speakers 714 that correspond to the command signal.

In addition to providing an output signal to the speakers 714 as one function to be performed, the controller 702 may additionally or alternatively interrupt the output signal of the engine throttle sensor that is being provided to the engine computer with built-in controller 702 to cause the engine computer to detect that no throttle is being applied by the operator so that the car continuously slows until it stops. Furthermore, the controller 702 may initiate a kill signal within the engine computer to kill the engine of the vehicle. As described below, the controller 702 may be configured to determine whether the vehicle is within the proper area identified by the command signal and/or whether the vehicle has been properly identified by the command signal prior to performing the command requested by the command signal.

In addition to receiving radio input, the passenger vehicle system 700 may also include a global positioning system (“GPS”) antenna 706 that feeds a GPS signal to a GPS receiver integrated into the controller 702. The controller 702 may then determine the coordinate position of the passenger vehicle and may compare this coordinate position to the location coordinates or range of coordinates provided in the command signal that is simultaneously being received. This allows the controller 702 to determine whether its location is within the parameters for acting upon the command signal. For example, the controller 702 may determine whether the vehicle is close enough to an emergency vehicle so that the command signal should be acted upon to provide an alert about the emergency vehicle through the speakers 714. As another example, the controller 702 may determine whether the vehicle is within a range of coordinates defining a coverage area of an emergency broadcasting message prior to providing the message through the speakers 714.

FIG. 8 shows the logical operations that occur within a passenger vehicle system, such as the passenger vehicles systems 500, 600, or 700, to receive a command signal and cause an audible alert to be provided to warn the occupants that an emergency vehicle is approaching. While these steps are discussed in relation to the passenger vehicle system 500 of FIG. 5, it will be appreciated that these steps are also applicable to the passenger vehicles systems 600 and 700 of FIGS. 6 and 7.

Initially, the controller 502 begins operation via activation of the ignition switch 510 at switch operation 802. The controller 502 immediately begins monitoring for a command signal via the radio antenna 508 at monitor operation 804. The controller 502 computes the coordinate location of the passenger vehicle using the GPS signal from the antenna 504 at location operation 806. During this time, the car radio 504 continues to receive commercial band radio broadcasts selected by the operator and provides the audio for these broadcasts to the speakers 514 due to the controller 502 allowing the commercial band radio and speaker output to pass-through unaffected at radio operation 808.

When a command signal transmission occurs within range of the passenger vehicle, the controller 502 then receives the command signal via the antenna 508 at reception operation 810. In the logical operations of FIG. 8, the command signal is an emergency warning about an approaching emergency vehicle. As discussed above, the command signal may be encrypted through one of various, well-known encryption schemes to minimize the chance that the command code can be discovered by eavesdropping and then re-used by someone with malicious intent. The controller 502 decrypts the incoming command signal as it is received via a scheme that is compatible with the encryption scheme used by the controller generating the transmission. Once decrypted, the command codes, GPS location coordinates or range, and any other information of the command signal may be extracted.

Once the information is extracted, the controller 502 at comparison operation 812 compares the GPS location coordinates or range specifying a coverage area to the GPS coordinates that have been determined at location operation 806. This comparison allows a computation of the distance between the passenger vehicle and the approaching emergency vehicle that is generating the transmission at distance operation 814. Furthermore, the closing rate of the emergency vehicle to the passenger vehicle may also be found by repetitively updating the GPS coordinates of the passenger vehicle and the obtaining updated GPS coordinates of the emergency vehicle from the continuous command signal to determine whether the emergency vehicle is closing in or moving away.

The controller 502 may be pre-programmed with a predefined distance as well as a predefined closing rate that determines whether the audible alert should be provided. When the comparison of distance and closing rate found from distance operation 814 to the predefined distance and closing rate determines that the values are not within the defined parameters, then no further action is taken at quiescent operation 816. In that case, the normal broadcast continues to be provided through the speakers 514. When the comparison of distance and closing rate found from distance operation 814 to the predefined distance and closing rate determines that the values are within the defined parameters, then the radio speaker output is interrupted at audio operation 818 by creating a disconnection between the speakers 514 and the radio speaker output. The controller 502 then provides the audible alert requested by the received command code to the speakers 514 at alert operation 820. Thus, the occupants hear the audible alert in place of the normal radio broadcast.

Once the emergency announcement has been made a predefined number of times, the controller 502 discontinues the audio signal to the speakers 514 and reconnects the radio speaker output to the speakers 514 at reconnection operation 822. The speakers 514 then resume the normal radio broadcast. As the normal radio broadcast resumes, the controller 502 continues to monitor for additional command signals including emergency warning signals at monitor operation 824.

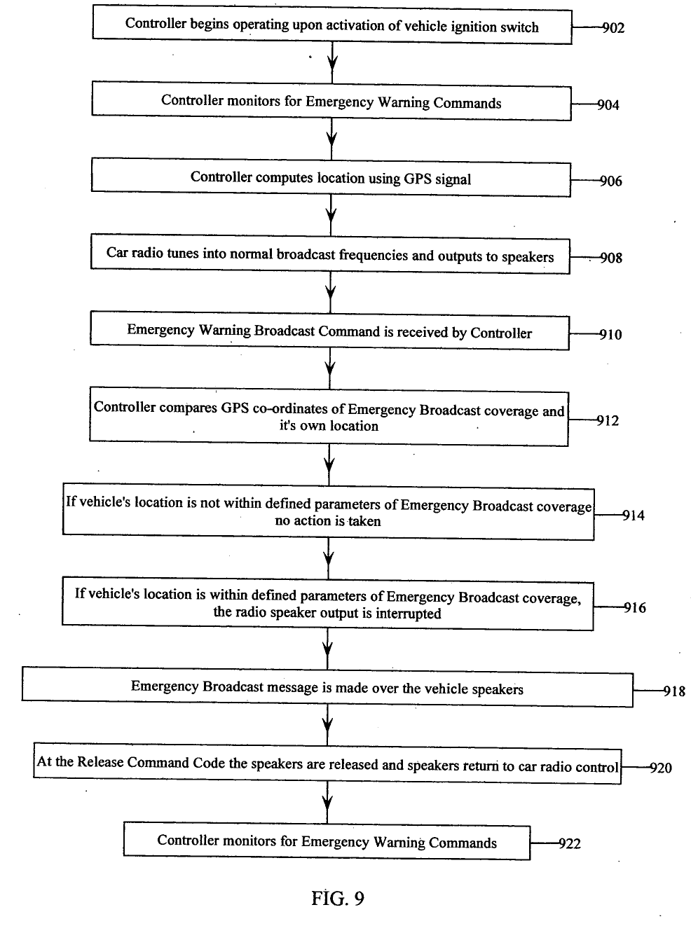

FIG. 9 shows the logical operations that occur within a passenger vehicle system, such as the passenger vehicles systems 500, 600, or 700, to receive a command signal and cause an emergency broadcast message to be provided to warn the occupants of an impending danger or other emergency situation. As noted above for FIG. 8, while these steps are discussed in relation to the passenger vehicle system 500 of FIG. 5, it will be appreciated that these steps are also applicable to the passenger vehicles systems 600 and 700 of FIGS. 6 and 7.

Initially, the controller 502 begins operation via activation of the ignition switch 510 at switch operation 902. The controller 502 immediately begins monitoring for a command signal via the radio antenna 508 at monitor operation 904. The controller 502 computes the coordinate location of the passenger vehicle using the GPS signal from the antenna 504 at location operation 906. During this time, the car radio 504 continues to receive commercial band radio broadcasts selected by the operator and provides the audio for these broadcasts to the speakers 514 due to the controller 502 allowing the commercial band radio and speaker output to pass-through unaffected at radio operation 908.

When a command signal transmission occurs within range of the passenger vehicle, the controller 502 then receives the command signal via the antenna 508 at reception operation 910. In the logical operations of FIG. 9, the command signal is an emergency broadcast message about an emergency situation. As discussed above, the command signal may be encrypted through one of various, well-known encryption schemes to minimize the chance that the command code can be discovered by eavesdropping and then re-used by someone with malicious intent. The controller 502 decrypts the incoming command signal as it is received via a scheme that is compatible with the encryption scheme used by the controller of the generating the transmission. Once decrypted, the command codes, GPS location coordinates or range, and any other information of the command signal may be extracted.

Once the information is extracted, the controller 502 at comparison operation 912 compares the GPS location coordinates or range specifying a coverage area to the GPS coordinates that have been determined at location operation 906. This comparison allows a computation of whether the vehicle is within the coverage area for the emergency broadcast message. When the comparison of vehicle location to the coverage area determines that the passenger vehicle is not within the coverage area, then no further action is taken at quiescent operation 914. In that case, the normal broadcast continues to be provided through the speakers 514. When the comparison of vehicle location to the coverage area determines that the passenger vehicle is within the coverage area, then the radio speaker output is interrupted at audio operation 916 by creating a disconnection between the speakers 514 and the radio speaker output. The controller 502 then provides the emergency broadcast message of the command signal to the speakers 514 as requested by the received command code at alert operation 918. Thus, the occupants hear the emergency broadcast message in place of the normal radio broadcast.

Once the emergency broadcast message has been provided through the speakers 514 a predefined number of times, the controller 502 discontinues the audio signal to the speakers 514 and reconnects the radio speaker output to the speakers 514 at reconnection operation 920. The speakers 514 then resume the normal radio broadcast. As the normal radio broadcast resumes, the controller 502 continues to monitor for additional command signals including emergency warning signals at monitor operation 922.

FIG. 10 shows the logical operations that occur within a passenger vehicle system, such as the passenger vehicles systems 500, 600, or 700, to receive a command signal and cause the vehicle to slow to a stop. As noted above for FIGS. 8 and 9, while these steps are discussed in relation to the passenger vehicle system 500 of FIG. 5, it will be appreciated that these steps are also applicable to the passenger vehicles systems 600 and 700 of FIGS. 6 and 7.

Initially, the controller 502 begins operation via activation of the ignition switch 510 at switch operation 1002. The controller 502 immediately begins monitoring for a command signal via the radio antenna 508 at monitor operation 1004. The controller 502 computes the coordinate location of the passenger vehicle using the GPS signal from the antenna 504 at location operation 1006. During this time, the car radio 504 continues to receive commercial band radio broadcasts selected by the operator and provides the audio for these broadcasts to the speakers 514 due to the controller 502 allowing the commercial band radio and speaker output to pass-through unaffected at radio operation 1008.

When a command signal transmission occurs within range of the passenger vehicle, the controller 502 then receives the command signal via the antenna 508 at reception operation 1010. In the logical operations of FIG. 9, the command signal is an emergency stop command. As discussed above, the command signal may be encrypted through one of various, well-known encryption schemes to minimize the chance that the command code can be discovered by eavesdropping and then re-used by someone with malicious intent. The controller 502 decrypts the incoming command signal as it is received via a scheme that is compatible with the encryption scheme used by the controller of the generating the transmission. Once decrypted, the command codes, GPS location coordinates or range, the vehicle identification information entered by the police officer, and any other information of the command signal may be extracted.

Once the information is extracted, the controller 502 at comparison operation 1012 compares the GPS location coordinates of the command signal to the GPS coordinates that have been determined at location operation 1006. This comparison allows a computation of the proximity of the passenger vehicle to the police vehicle. The controller 502 also compares the identification information of the command signal to the identification value of the vehicle at comparison operation 1014.

As discussed above in relation to FIG. 2B, the identification information may be the VIN for the vehicle or it may be other information to single out the vehicle, such as an approximate current speed and approximate distance from the police vehicle as determined by comparison operation 1012. The VIN is stored in memory of the controller 502 and can be accessed for the comparison. The actual speed of the vehicle may be determined by repeated GPS coordinate comparisons with respect to time or from a query to the computer of the vehicle that tracks the current speed.

When the comparison of vehicle information of the command signal to the actual vehicle information determines that the passenger vehicle is not likely the passenger vehicle targeted by the police officer, then no further action is taken at quiescent operation 1016. In that case, the passenger vehicle proceeds ahead under full control of the operator. When the comparison of vehicle information of the command signal to the actual vehicle information determines that the passenger vehicle is likely the passenger vehicle targeted by the police officer, then the engine throttle sensor output is interrupted at throttle operation 1018 by creating a disconnection between the engine throttle sensor 516 and the computer of the vehicle. This results in the computer of the vehicle applying no throttle regardless of the actual throttle input of the operator so that the car begins slowing down.

The controller 502 of this embodiment continues to detect the current speed of the passenger vehicle. Once the vehicle slows to a predefined speed, the controller 502 may then instruct the vehicle's computer to shut off the engine at engine operation 1020. As an alternative, the controller 502 may also include an output connection to a switch in the ignition system so that the controller 502 may itself shut down the engine. After stopping the passenger vehicle, the controller 502 may maintain the switch in the off position to prevent the engine from starting until a command signal with a reset command code is transmitted to the controller 502 at reset operation 1022. Once reset, the controller 502 resumes monitoring for command signals such as emergency warning commands at monitor operation 1024 when activated by the vehicle ignition switch 510.

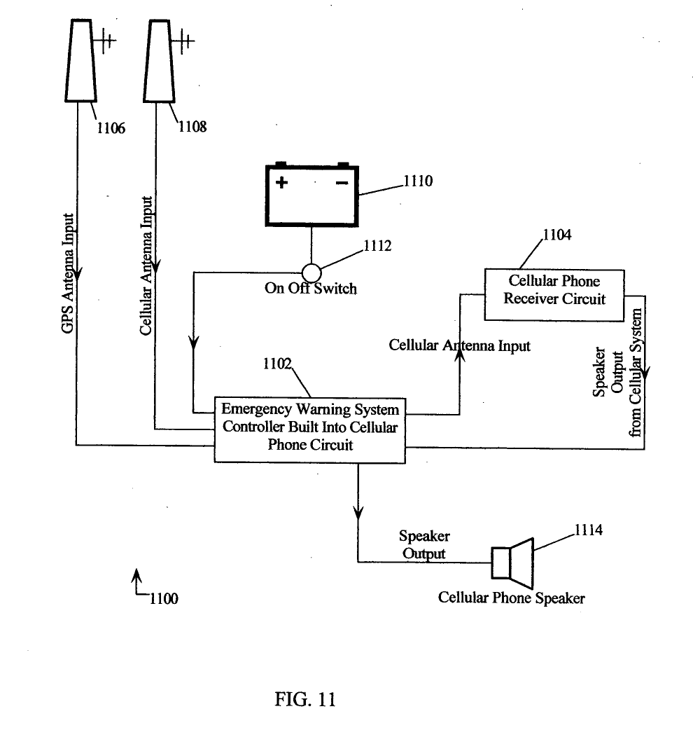

FIG. 11 illustrates the components that may be included in the original equipment of a cellular telephone to allow the cellular telephone to receive command signals and act upon the command signals to perform a particular function by taking control of a control element of the telephone. In the example of FIG. 11, the control element includes the speaker 1114 that provides audio output to the cellular telephone user.

The cellular telephone system 1100 of FIG. 11 includes an emergency warning system controller 1102 that is built into the circuitry of the cellular telephone. The controller 1102 receives various input signals and generates various output signals to provide for execution of a function specified by the command signals. The controller 1102 may receive electrical power from the electrical system 1110 already present in a cellular telephone. The electrical system 1110 typically includes a direct current battery that is charged by an external charging system such as a charging cradle. The electrical power provided to the controller 1102 may be controlled by the power switch 1112 of the telephone so that the controller 1102 is operable to receive and execute command signals only when the telephone has been switched on. Once switched on, the controller 1102 remains in an active mode listening for command signals.

In addition to receiving electrical power as input, the controller 1102 also receives command signals that have been received by a radio system antenna 1108 that is already standard in cellular telephones and that is otherwise used to receive cellular telephone communication signals. The command signal that has been received by the antenna 1108 is channeled to the controller 1102 where the various components of the command signals are extracted. As mentioned above, the controller 1102 includes a radio frequency receiver that is permanently tuned to one or more channels that are dedicated to the command signal transmissions. Thus, the user of the cellular telephone is not required to tune the controller 1102 to any particular channel prior to receiving a command signal. Accordingly, the controller 1102 receives and acts upon the command signal without any action being taken by the user.

The controller 1102 is installed in-line between the antenna 1108 and the antenna input of the existing cellular telephone receiver circuit 1104. The controller 1102 acts as a pass-through between the antenna 1108 and receiver circuit 1104 to allow cellular telephone communications signals to be tuned in by the receiver circuit 1104 from the antenna 1108. The controller 1102 may also be installed in-line between the speaker output of the receiver circuit 1104 and the speaker 1114. The controller 1102 acts as a pass-through between the receiver circuit 1104 and speaker 1114 so that audio from received cellular telephone signals continues to be played through the speaker 1114. However, the controller 1102 includes switching circuitry to intervene and disconnect the speaker 1114 from the speaker output of the receiver circuit 1104 and instead provide audio signals to the speaker 1114 that correspond to the command signal.

In addition to receiving radio input via antenna 1108, the cellular telephone system 1100 may also include a global positioning system (“GPS”) antenna 1106 that feeds a GPS signal to a GPS receiver integrated into the controller 1102. The controller 1102 may then determine the coordinate position of the cellular telephone and may compare this coordinate position to the location coordinates or range of coordinates provided in the command signal that is simultaneously being received. This allows the controller 1102 to determine whether its location is within the parameters for acting upon the command signal. For example, the controller 1102 may determine whether the cellular telephone is within a range of coordinates defining a coverage area of an emergency broadcasting message prior to providing the message through the speaker 1114.

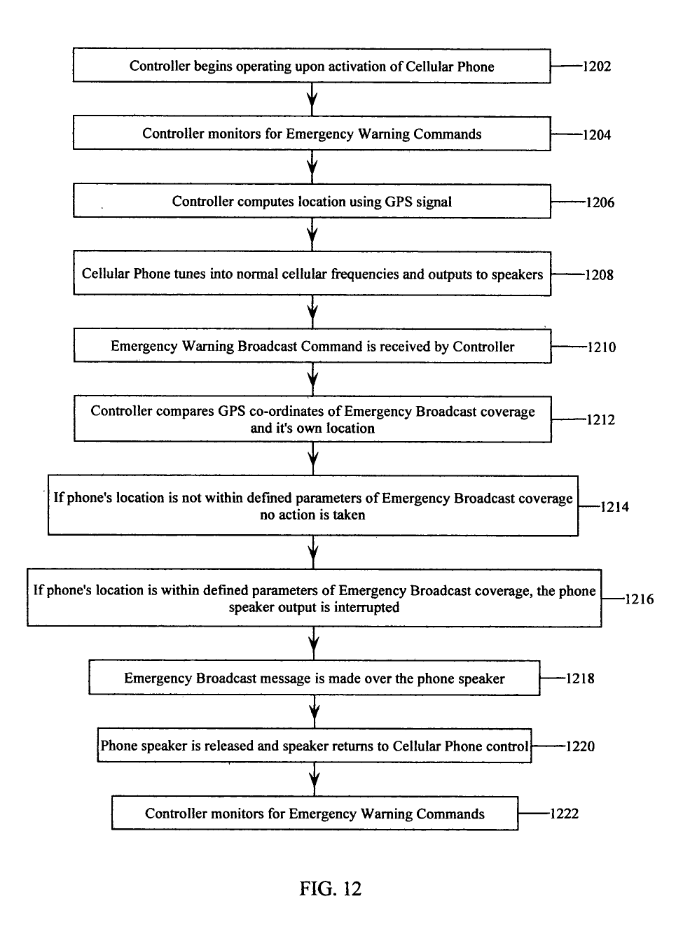

FIG. 12 shows the logical operations that occur within a cellular telephone system, such as the cellular telephone system 1100, to receive a command signal and cause an emergency broadcast message to be provided to warn the user of an impending danger or other emergency situation. Thus, the user may be warned by the emergency broadcast message even if the user is not within a vehicle equipped with an emergency warning system as shown in FIGS. 5-7 so long as the user carries a remote device such as a cellular telephone that is equipped with an emergency warning system. For example, the user may be on a mass transit vehicle or simply walking along a sidewalk and can be alerted to an impending danger that is in close proximity to the user.

Initially, the controller 1102 begins operation via activation of the power switch 1112 at switch operation 1202. The controller 1102 immediately begins monitoring for a command signal via the radio antenna 1108 at monitor operation 1204. The controller 1102 computes the coordinate location of the telephone using the GPS signal from the antenna 1104 at location operation 1206. During this time, the receiver circuit 1104 continues to receive cellular telephone communication signals and provides the audio for these signals to the speaker 1114 due to the controller 1102 allowing the cellular telephone signals and speaker output to pass-through unaffected at receiver operation 1208.

When a command signal transmission occurs within range of the cellular telephone, the controller 1102 then receives the command signal via the antenna 1108 at reception operation 1210. In the logical operations of FIG. 12, the command signal is an emergency broadcast message about an emergency situation. As discussed above, the command signal may be encrypted through one of various, well-known encryption schemes to minimize the chance that the command code can be discovered by eavesdropping and then re-used by someone with malicious intent. The controller 1102 decrypts the incoming command signal as it is received via a scheme that is compatible with the encryption scheme used by the controller of the generating the transmission. Once decrypted, the command codes, GPS location coordinates or range, and any other information of the command signal may be extracted.

Once the information is extracted, the controller 1102 at comparison operation 1212 compares the GPS location coordinates or range specifying a coverage area to the GPS coordinates that have been determined at location operation 1206. This comparison allows a computation of whether the telephone is within the coverage area for the emergency broadcast message. When the comparison of telephone location to the coverage area determines that the telephone is not within the coverage area, then no further action is taken at quiescent operation 1214. In that case, the audio from the cellular signals, if any, continues to be provided through the speaker 1114. When the comparison of telephone location to the coverage area determines that the telephone is within the coverage area, then the receiver circuit speaker output is interrupted at audio operation 1216 by creating a disconnection between the speaker 1114 and the receiver circuit speaker output. The controller 1102 then provides the emergency broadcast message of the command signal to the speaker 1114 as requested by the received command code at alert operation 1218. Thus, the user hears the emergency broadcast message in place of the audio from the cellular communication signals.

Once the emergency broadcast message has been provided through the speaker 1114 a predefined number of times, the controller 1102 discontinues the audio signal to the speaker 1114 and reconnects the receiver circuit speaker output to the speaker 1114 at reconnection operation 1220. The speaker 1114 then resumes the audio of the cellular communication signal. As the audio of the cellular communication signal resumes, the controller 1102 continues to monitor for additional command signals including emergency warning signals at monitor operation 1222.

As described above, various systems may be utilized to generate command signals during various types of emergency situations to cause a control element of a remote device that is normally under full control of an operator to perform a function. As noted above, examples include causing the radio system of a vehicle or cellular telephone to provide an audible emergency broadcast message. Another example includes causing the radio system of a vehicle to provide an audible alert of an approaching emergency vehicle. An additional example provided above includes causing interruption of the throttle sensor output of a vehicle to cause the vehicle to slow to a stop when being pursued. Accordingly, dangers present due to the emergency situation may be mitigated to some degree.

While the invention has been particularly shown and described with reference to various embodiments thereof, it will be understood by those skilled in the art that various other changes in the form and details may be made therein without departing from the spirit and scope of the invention.

1. A system for causing an action at a remote device during an emergency situation, comprising:
a transmitter under the control of emergency personnel, the transmitter wirelessly transmitting a command signal upon activation by the emergency personnel; and
a device located remotely from the transmitter, the device including a control element being under the control of an operator during normal operation, the device further including an antenna that receives the command signals and a controller that acts upon the command signals received by the antenna to take control of the control element.

2. The system of claim 1, wherein the device is a passenger vehicle, wherein the antenna receives normal commercial band radio broadcasts in addition to the command signals, wherein the passenger vehicle includes a radio, and wherein the control element is the speakers of the passenger vehicle such that the radio plays the radio broadcasts through speakers during normal operation and the controller provides an audible message through the speakers upon receiving the command signal.

3. The system of claim 2, wherein the transmitter is located within an emergency vehicle, wherein the antenna receives the command signal upon the emergency vehicle coming within proximity to the passenger vehicle, and wherein the command signal causes the controller to provide an audible message through the speaker to occupants of the passenger vehicle that warns the occupants about the emergency vehicle being in proximity.

4. The system of claim 3, further comprising:
a global positioning system antenna of the emergency vehicle that provides signals to a controller to detect the position of the emergency vehicle; and
a global positioning system antenna providing signals to the controller of the passenger vehicle to detect the position of the passenger vehicle, wherein the command signal includes the position detected for the emergency vehicle, and wherein the controller detects whether the position of the emergency vehicle is within a pre-defined distance of the position of the passenger vehicle and provides the audible message only upon the emergency vehicle being within the pre-defined distance.

5. The system of claim 4, wherein the controller further detects whether a closing rate of the emergency vehicle is within a pre-defined amount relative to the passenger vehicle and provides the audible message only upon the closing rate being with the pre-defined amount.

6. The system of claim 2, wherein the command signal causes the controller to provide an audible message through the speaker to occupants of the passenger vehicle that provides information to the occupants of the passenger about the emergency situation.

7. The system of claim 1, wherein the device is a cellular telephone, wherein the antenna receives normal cellular telephone signals in addition to the command signals, and wherein the control element is a speaker of the cellular telephone such that the cellular telephone plays cellular telephone signals through the speaker during normal operation and the controller provides an audible message through the speaker upon receiving the command signal.

8. The system of claim 7, wherein the command signal causes the controller to provide an audible message through the speaker to an operator of the cellular telephone that informs the operator of the cellular telephone about the emergency situation.

9. The system of claim 1, wherein the device is a passenger vehicle, wherein the antenna receives normal commercial band radio broadcasts in addition to the command signals, wherein the passenger vehicle includes a radio, and wherein the control element comprises an engine throttle sensor of the passenger vehicle such that the engine throttle sensor is under control of the operator of the passenger vehicle during normal operation and the controller then interrupts an output of the engine throttle sensor to slow the passenger vehicle upon receiving the command signal.

10. A method of providing information during emergency situations where a plurality of vehicles include a radio system that includes an antenna, radio, and speakers for providing normal commercial band radio operation and where the one or more vehicles also include a controller interconnected to the radio system, comprising:
receiving a command signal in addition to commercial band broadcast radio through an antenna of each of the plurality of vehicles;
detecting at the controller of each of the plurality of vehicles that the command signal has been received; and
after detecting that the command signal has been received, interrupting the normal commercial band radio operation at each of the plurality of vehicles to provide an audible message from the controller through the speakers.

11. The method of claim 10, wherein providing the audible message from the controller through the speakers comprises muting a normal commercial band radio broadcast being provided through the speakers prior to receiving the command signal.

12. The method of claim 10, further comprising:
broadcasting the command signal from an emergency vehicle in proximity such that the command signal may be received and detected by each of the plurality of vehicles, and wherein providing the audible message from the controller through the speakers comprises providing an alert about the emergency vehicle.

13. The method of claim 10, further comprising:
obtaining at an at least one vehicle the global positioning system coordinates for the at least one vehicle;
obtaining at the at least one vehicle the global positioning system coordinates of the emergency vehicle;
computing the distance between the at least one vehicle and the emergency vehicle; and
interrupting the normal commercial band radio operation at the at least one vehicle to provide the audible message only when the distance that is computed is less than a pre-defined distance.

14. The method of claim 13, further comprising:
detecting whether a closing rate of the emergency vehicle is within a pre-defined amount relative to the at least one vehicle; and
interrupting the normal commercial band radio operation at the at least one vehicle to provide the audible message only when the closing rate that is detected is within a pre-defined amount.

15. The method of claim 10, further comprising:
broadcasting the command signal from an emergency broadcast tower such that the command signal may be received and detected by each of the plurality of vehicles, and wherein providing the audible message from the controller through the speakers comprises providing a message being broadcast with the command signal from the broadcast tower.

16. A method of controlling a function of a vehicle during an emergency situation where the vehicle includes a radio system having an antenna that receives normal commercial band radio broadcasts, a control system, and a controller that is interconnected to the radio system and that detects command signals, comprising:
receiving a command signal through the antenna;
detecting at the controller that the command signal has been received; and
after receiving the command signal, issuing a control signal from the controller to the control system to control a function of the vehicle.

17. The method of claim 16, wherein the vehicle has a unique identifier and wherein the command signal provides an identifier, the method further comprising:
upon detecting at the controller that the command signal has been received, determining from the command signal whether the identifier included in the command signal matches the identifier of the vehicle; and
when the identifier of the command signal does match the identifier of the vehicle, then issuing the control signal from the controller to the control system.

18. The method of claim 16, wherein the function of the vehicle is the engine speed, wherein the control system is an engine throttle sensor, and wherein the control signal issued from the controller to the engine throttle sensor interrupts an output of the engine throttle sensor to slow the vehicle.

19. The method of claim 16, further comprising transmitting the command signal from a law enforcement vehicle that is pursuing the vehicle.

20. The method of claim 17, further comprising transmitting the command signal from a law enforcement vehicle that is pursuing the vehicle.

21. The method of claim 18, further comprising transmitting the command signal from a law enforcement vehicle that is pursuing the vehicle.
